(19) United States
(12) Patent Application Publication
(10) Pub. No.: US 2010/0057770 A1
(43) Pub. Date: Mar. 4, 2010

(54) System and method of file management, and recording medium storing file management program

(75) Inventor: Hiroya Kumashio, Inba-gun (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/585,065

(22) Filed: Sep. 2, 2009

(30) Foreign Application Priority Data
Sep. 3, 2008 (JP) 2008-225518

(51) Int. Cl. G06F 7/00; G06F 12/00

(52) U.S. Cl. 707/102; 707/200; 707/E17.01; 707/E17.044

(57) ABSTRACT

A system and a method of managing a data file using a plurality of folders arranged in a plurality of layers are provided. From the data file, classification information is extracted, which includes a plurality of bibliographic items. A registration folder to which the data file is to be registered is specified using the classification information. The data file is registered to the registration folder included in the plurality of folders arranged in the plurality of layers.

### CROSS-REFERENCE TO RELATED APPLICATIONS

This patent application is based on and claims priority under 35 U.S.C. §119 to Japanese Patent Application No. 2008-225518, filed on Sep. 3, 2008, in the Japanese Patent Office, the disclosure of which is hereby incorporated herein by reference.

### FIELD OF THE INVENTION

The present invention generally relates to a system and a method of managing a data file such as a document data file using a folder, and to a recording medium storing a computer program for managing a data file such as a document data file using a folder.

### BACKGROUND

The information processing apparatus may be provided with software application for generating or editing document data or image data, and an operating system (OS) such as the Windows. The recent OS is provided with many functions so as to improve the functionality, user operability, or usability. For example, the OS may allow the user to manage or classify various document data or image data that has been created.

The Japanese Patent Application Publication No. H07-13828 describes an file management system which includes classification information generating means which sets and manages classification information for file classification in a file or directory, an automatic file storage means which automatically classifies and stores files according to the classification information, a file generating and detecting means which monitors file generation and informs the automatic file storage means of the generation of the file, and a file kind determining means which determines the kind of the file by checking the contents of the file and informs the automatic file storage means.

When the user generates the file or when a predetermined storage time period passes, the file is automatically classified and stored. When a predetermined time period reaches the time for disposing the file, the file is deleted.

However, when the user selects to manually manage the files using a folder, the user needs to generate a folder for file classification, determine the file classification after reviewing the contents of the file, and move or copy the file to the folder that is determined based on the file classification. Since the user needs to manually create a number of folders for file classification, or the user needs to move or copy the file to the folder, this has been cumbersome for the user.

In order to solve this problem, the file management system of the Japanese Patent Application Publication No. H07-13828 sets the classification information, and automatically classifies the files according to the classification information. However, this automatic classification function may not work well when more than one folder is created using a tree structure in which a plurality of folders is arranged in layers. Even when the file is classified into the folder, is has been difficult for the user to find out to which folder the file is classified.

### SUMMARY

In view of the above, there is a need for a system or a method of managing a data file with improved efficiency.

Example embodiments of the present invention include a file management system of managing a data file using a plurality of folders arranged in a plurality of layers having a tree structure. The system includes a controller device to automatically manage the data file using the plurality of folders arranged in the plurality of layers. The controller device extracts classification information from the data file, which includes a plurality of bibliographic items relating to the contents of the data file. The controller device specifies a registration folder to which the data file is to be registered by specifying, layer by layer, the plurality of folders using the plurality of bibliographic items of the classification information. The registering device registers the data file to the registration folder included in the plurality of folders arranged in the plurality of layers.

In addition to the above-described example embodiments, the present invention may be practiced in various other ways, for example, as a method of managing a data file or a recording medium storing therein a plurality of instructions which cause a computer to perform a method of managing a data file.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a structure of a file management apparatus functioning as a file management system according to an example embodiment of the present invention;

FIG. 2 is a schematic block diagram illustrating a functional structure of the file management system of FIG. 1;

FIG. 3 is a screen for displaying a plurality of folders and a plurality of data files respectively managed by the file management system of FIG. 1;

FIG. 4 is an illustration for explaining a plurality of folders in layers, managed by the file management system of FIG. 1;

FIG. 5 is a data structure of a table storing bibliographic items, provided by the file management system of FIG. 1;

FIG. 6 is an operation screen for allowing a user to designate a classification folder of the file management system of FIG. 1;

FIG. 7 is an illustration for explaining operation of generating a plurality of folders in layers using the file management system of FIG. 1;

FIG. 8 is an illustration for explaining a plurality of folders in layers generated in the classification folder of the file management system of FIG. 1;

FIG. 9 is an illustration for explaining operation of designating one of the plurality of folders to the classification folder, using the file management system of FIG. 1;

FIG. 10 is a flowchart illustrating operation of managing a data file using a plurality of folders in layers, performed by the file management system of FIG. 1, according to an example embodiment of the present invention;

FIG. 11 is an illustration for explaining operation of registering a file to the classification folder when the layered folders are not generated;

FIG. 12 is an illustration for explaining operation of registering a file to the classification folder when the layered folders are generated;

FIG. 13 is an illustration for explaining operation of registering a file to the classification folder when a part of the layered folders is generated;

FIG. 14 is a flowchart illustrating operation of updating the classification information of the data file that has been registered, performed by the file management system of FIG. 1, according to an example embodiment of the present invention; and

FIG. 15 is an illustration for explaining operation of updating the classification information of the data file that has been registered.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

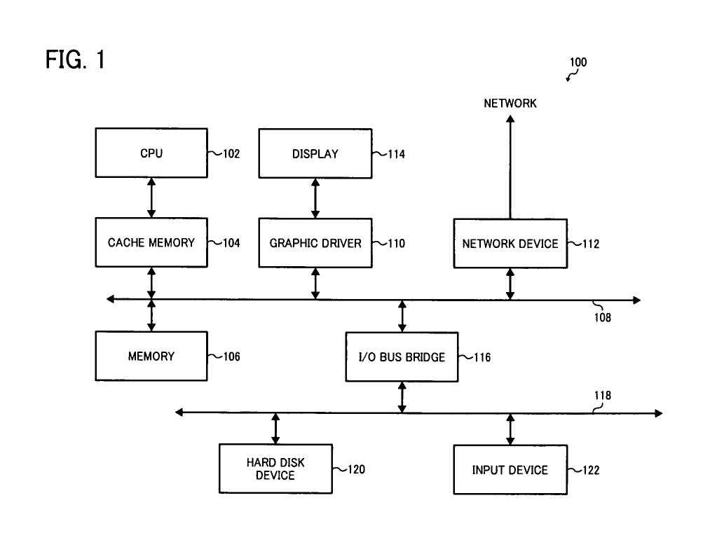

Referring to FIG. 1, a structure of a file management apparatus 100, which functions as a file management system, is explained according to an example embodiment of the present invention. For the illustrative purpose, the file management apparatus 100 and the file management system 100 may be used interchangeably. The file management apparatus 100 is capable of managing one or more data files using folders, which are created in layers. The file management apparatus 100 may be implemented by, for example, an information processing apparatus such as a personal computer or a work station. Alternatively, the file management apparatus 100 may be implemented by a functional system module, which may be included in an image processing apparatus such as a multifunctional apparatus (MFP).

The data file to be managed by the file management apparatus 100 may be a data file of any desired type including, for example, a document data file or an image data file. The specific data area of the data file, such as the header area or the metadata area, includes classification information regarding a plurality of layers to be used for classifying the data file. The classification information includes a plurality of layer names each corresponding to one of the plurality of layers to be used for classifying the data file. The classification information further includes one or more folder names each assigned to one or more folders generated for each layer of the plurality of layers. The folder name may be used to specify a registration folder that is selected from the plurality of folders for registering therein the data file. The plurality of folder names of the plurality of folders generated for each layer is stored with respect to corresponding one of the plurality of layers, as the bibliographic items, together with the plurality of layer names. The plurality of layer names may be each assigned based on the genre or category relating to the contents of the data file to be managed. The plurality of folder names may be each assigned based on a specific item or attribute belonging to the genre or the category relating to the contents of the data file to be managed. As described below, the classification information is referred when managing the data files for classification. The folders are registered for each layer of the plurality of layers used for classifying the data file, layer by layer. The classification information is used to specify the folder to which the data file is stored or registered.

The file management apparatus 100 includes a central processing unit (CPU) 102, which has a plurality of functions including extracting, generating, registering, classifying, and designating. The file management apparatus 100 further includes a cache memory 104 to provide the high-speed data access for the CPU 102, and a system memory 106 which functions as a work area of the CPU 102 and is implemented by a solid memory element such as a random access memory (RAM) or dynamic RAM (DRAM).

The CPU 102, the cache memory 104, and the system memory 106 are connected to other devices or drives of the file management apparatus 100 through a system bus 108. The other devices or drives of the file management apparatus 100 include, for example, a graphics driver 110, and a network device 112 such as a network interface circuit (NIC). The graphics driver 110, which is connected to a display 114 through a bus, causes the display 114 to display on its screen the processing result of the CPU 102. The network device 112 allows the file management apparatus 100 to connect to a network according to the TCP/IP protocol to establish a session such as a session for LDAP searching in compliance with the HTTP protocol, FTP protocol, ITU-T recommendation X.500, etc.

The file management apparatus 100 further includes an input/output (I/O) bus bridge 116, which is connected to an I/O bus 118 such as peripheral component interconnect (PCI). A hard disk device 120 such as a hard disk drive (HDD) may be provided downstream the I/O bus bridge 116 through the I/O bus 118. The hard disk device 120 may be in compliance with the standard such as IDE, ATA, ATAPI, Serial ATA, SCSI, and USB. The hard disk device 120 stores a plurality of folders, each of which functions as a virtual data area for registering each data file, respectively within the classification folder for file management. The plurality of folders is stored in a layered structure having a plurality of layers.

The I/O bus 118 is connected through a bus such as USB to an input device 122. The input device 122, which may be implemented by a keyboard, a pointing device such as a mouse, etc., receives a user instruction or a user input made by a user. When the user instruction is received through the input device 122 such as the pointing device, such user instruction is reflected on the screen displayed by the display 114 so as to allow the user to perform operation of inputting, setting, and designating through the screen.

The CPU 102 may be implemented by any desired processor including, for example, Pentium, Pentium IV, Pentium compatible CPU, Power PC, and MIPS. The CPU 102 may be implemented by a processor having any desired architecture of single core or multiple cores.

As described below, the CPU 102 executes a program stored in the hard disk device 120 to perform operation of controlling each unit of the file management apparatus 100, or managing, writing, reading, or computing various data or information.

More specifically, the CPU 102 executes a program such as document management application 212 to perform operation of analyzing the data file to extract the classification information from the data file, generating the folders in layers based on the extracted classification information, and registering the data file to the folder specified based on the extracted classification information.

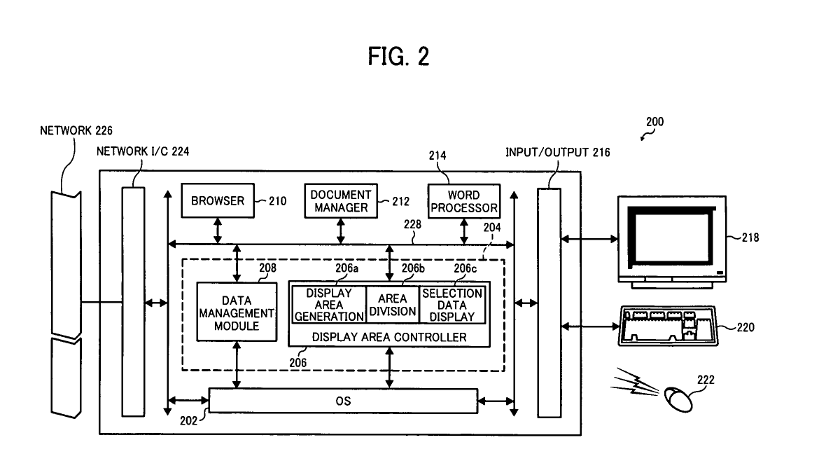

The CPU 102 may execute a program such as the document management application 212 to cause the CPU 102 to function as a display area controller 206 (FIG. 2) or a data management module 208 (FIG. 2).

Examples of the operating system (OS) for use include, but not limited to, MacOS, Windows, Windows 200X, Server, Unix, AIX, and LINUX. The file management apparatus 100 stores various application programs which are operated on the OS and written in any desired programming language such as the object-oriented programming language including, for example, C++, Visual C++, Visual Basic, Java, Perl, and Ruby.

Referring to FIG. 2, a structure of a functional block 200 of the file management apparatus 100 is explained according to an example embodiment of the present invention. When the CPU 102 executes the programs of various types, the file management apparatus 100 is caused to have the functional block 200. The functional block 200 of FIG. 2 includes the OS 202 for controlling the entire operation of the file management apparatus 100, and the other component such as a complier, linker, and assembler each may be provided on the OS 202. In this example, the functional block 200 includes a programming language module 204, which provides various functions through the visual C++, byte code, oe interpreter, which may be written in Java.

The programming language module 204 allows execution of the object-oriented programming codes, which may be displayed on a multi-window. The programming language module 204 includes the display area controller 206, which controls window generation, layout change, or window deletion. The programming language module 204 further includes the data management module 208, which instructs various processing based on the selection of various icons or hot spots.

The programming language module 204 detects the mouse event performed on the window formed on the display by the application program 210, 212, or 214 or the key sequence event corresponding to the mouse event. Based on the detection, the programming language module 204 calls an object to execute the requested processing, which is requested by the detected event. The display area controller 206 may correspond to a functional module, which is a collection of window control modules including the Window class modules, frame class modules, or scroll class modules. In this example referring to FIG. 2, the display area controller 206 includes a display area generation module 206a for window generation, an area division module 206b for dividing a frame displayed on the display area into smaller areas to generate divided frames, and a selection data display module 206c.

The display area generation module 206a generates the display area on the screen displayed by the display 114, which may be referred to as a window of multi-window type or a main display screen. Within the window, the positional coordinate is generated so as to allow generation of a frame, which is divided from the window. The area division module 206b divides the original frame defined within the window, which may be referred to as the second division area, based on the data selection, scroll, or change page processing to generate a divided frame. The selection data display module 206c selects a data set to be displayed on each one of the divided frames, and assigns the data set to corresponding one of the divided frame.

The display area controller 206 performs processing according to the user instruction detected through the display screen of the display 114. More specifically, the display area controller 206 controls each functional module of the window generation module 206a, the area division module 206b, and the selection data display module 206c, and causes the display 114 to graphically display the layered folders or each data file in the folder.

According to the user instruction detected through the screen displayed by the display 114, the data management module 208 performs processing of registering each data file to the folder, generating a new folder, moving the folder, deleting the folder, copying the folder, and storing the folder in the hard disk device 120.

The application programs 210, 212, and 214, which are each programmed according to the context of the programming language module 204, may be any desired type of application programs. In this example, the application programs may be the browser application 210, the document management application 212, and the word processor application 214. Alternatively or additionally, the image processing application, or the graphics application may be provided.

The browser application 210 may be implemented using the Internet Explorer, Netscape Navigator, Mozilla, or Opera. The browser application 210 includes a HTML or XML parser for analyzing structural data received from the web server, and displays the data based on the structural data on the window. The browser application 210 is capable of processing Java Script or Java Applet so as to dynamically change a web page according to a user instruction.

The document management application 212 may edit or search document data or image data, which may be stored in an information processing apparatus. The document management application 212 may edit or search any desired data such as the data managed by the document management application 212 or the data obtained through accessing a database of a server connected to the file management apparatus 100 through the network. The word processor application 214 generates document data, and registers the document data in a hard disk device such as the hard disk device 120 or a database of a server located outside of the file management apparatus 100.

The data is input to or output from the application program through an input/output 216. The application programs transmit or receive data through the display 218, the keyboard 220, and the mouse 222, using the VGA, USB, or IEEE802.X to perform data input or output. The application programs may be each connected to the network 226 through the network I/O 224 using the TCP/IP protocol to be connected to the LAN or the Internet to transmit or receive data to or from the other information processing apparatus or the server.

The functional modules may each perform interprocess communication through a bus 228 using the signal or socket communication method. The functional modules are thus cooperatively operated to realize the functional module of the file management apparatus 100.

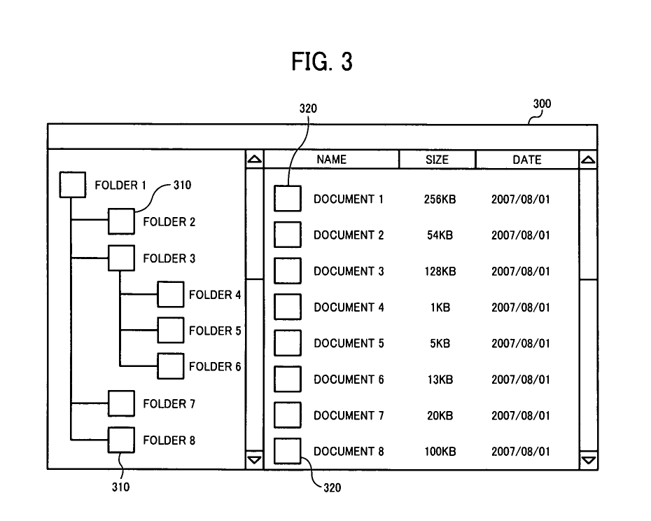

FIG. 3 illustrates a display screen 300, which displays a plurality of folders and a plurality of data files to be managed by the file management apparatus 100. The display screen 300 is divided into a right section and a left section. The left section displays thereon a plurality of folders 310 stored in the hard disk device 120. The right section displays thereon a list of data files 320, such as the document data, to be registered in one of the folders 310.

The data files 320 or the folders 310 that are displayed on the display screen 300 are displayed in the form of graphical symbol, which may be referred to as an icon. With respect to the icon, a user may perform operation of selecting by clicking with the input device 122, operation of moving or copying by performing the drag-and-drop with the input device 122, and operation of setting by double-clicking with the input device 122.

Any portion of the data files 320 or the folders 310 that is not displayed on the display screen 300 may be displayed by scrolling a display area with a scroll bar, which is formed at the ends of the display area of the data files 320 and the folders 310.

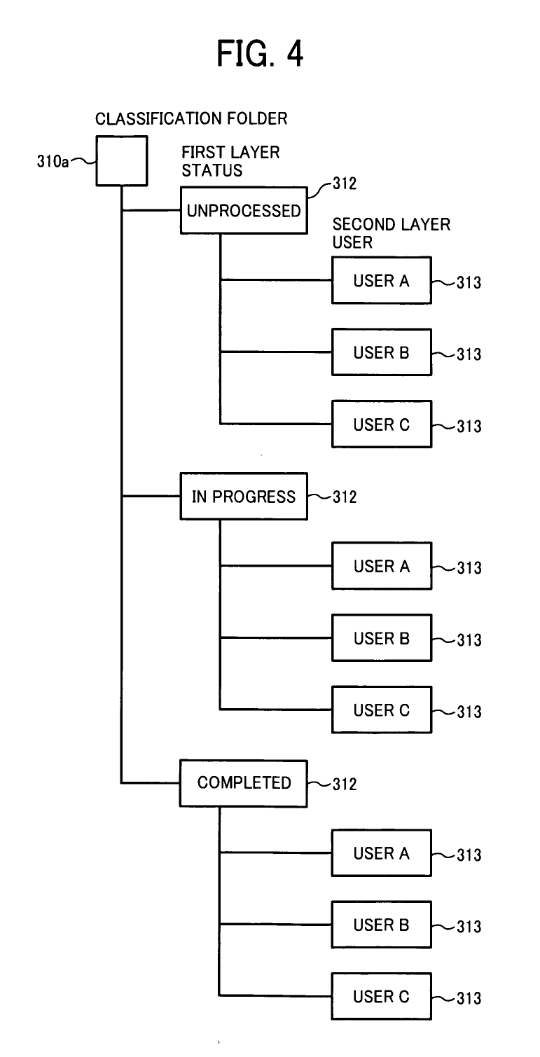

FIG. 4 illustrates a structure of folders, which are generated in layered structure in the classification folder 310a of the folders 310 by the data management module 208. In this folder structure, the classification folder 310a is displayed, which is located at the upper most layer. From the icon of the classification folder 310a, a plurality of connection lines are extended to indicate the layers that are located below, which may be referred to as a first layer. At the nodes of this tree structure, each of the folders 312 located in the first layer is arranged. From each of the folders 312, a plurality of connection lines is extended to form a tree structure. At the nodes of this tree structure, each of the folders 313 located in a second layer is arranged.

As illustrated in FIG. 4, the folders 312 are respectively assigned with the names “Unprocessed”, “In progress”, and “Completed”. The folders 313 are respectively assigned with the names “User A”, “User B”, and “User C”. These names are set by the data management module 208 according to the classification information included in the data file.

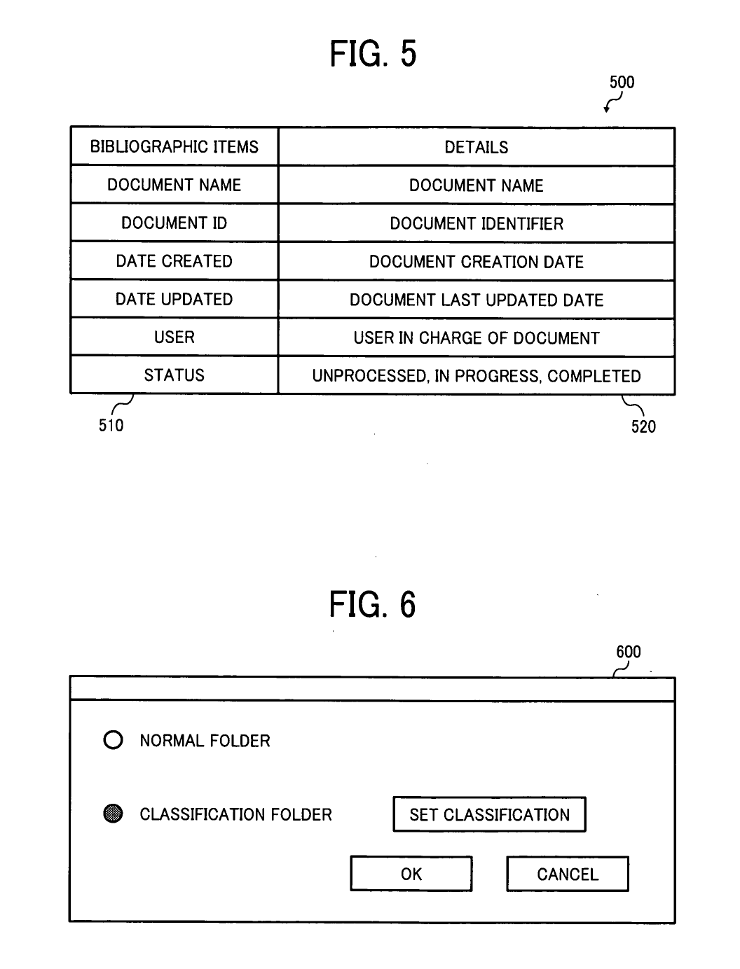

FIG. 5 illustrates a data structure of a table 500, which stores bibliographic items 510, which is to be used for setting each layer of the tree structure according to the user instruction. The table 5, which may be stored in the hard disk device 120, is managed by the document management application 212. Upon execution of the document management application 212, the table 5 is read onto a memory such as the RAM for further processing. The table 500 includes bibliographic items 510 included in the classification information, and detailed information for the bibliographic items 510, in a corresponding manner. The bibliographic items 510 stored in the table 500 may be assigned to the names of the respective layers according to a user instruction when generating the tree structure including the layers. The bibliographic items 510 stored in the table 500 each correspond to the bibliographic items stored in the data file. Any one of the bibliographic items 510 may be set as the classification information used for classifying the data file. For example, the bibliographic items 510 may correspond to property data of the data file, which may be set by default or modified by the user. The bibliographic items 510 may correspond to the property names, and the detailed information 520 of the bibliographic items 510 may correspond to the property values.

FIG. 6 illustrates an operation screen 600, which is used to designate the classification folder 310a to be automatically managed by the data management module 208, from the folders 310 displayed on the display screen 300. For example, when the user selects the folder 310 from the screen of FIG. 3 to execute operation of setting the classification folder, the operation screen 600 of FIG. 6 may be displayed. The operation screen 600 is provided with a first radio button for setting the selected folder 310 to be the normal folder not subjected to management by the data management module 208, and a second radio button for setting the selected folder 310 to be the classification folder to be managed by the data management module 208. The operation screen 600 further includes a “Set Classification” button to generate folders in layers to be generated in the folder 310, an “OK” button for confirming the selection made through the radio buttons or the “Set Classification” button, and a “Cancel” button for canceling the selection made through the radio buttons or the “Set Classification” button. Through the operation screen 600, the user may designate any folder 310 to be the classification folder, which is to be managed by the data management module 208 for classification.

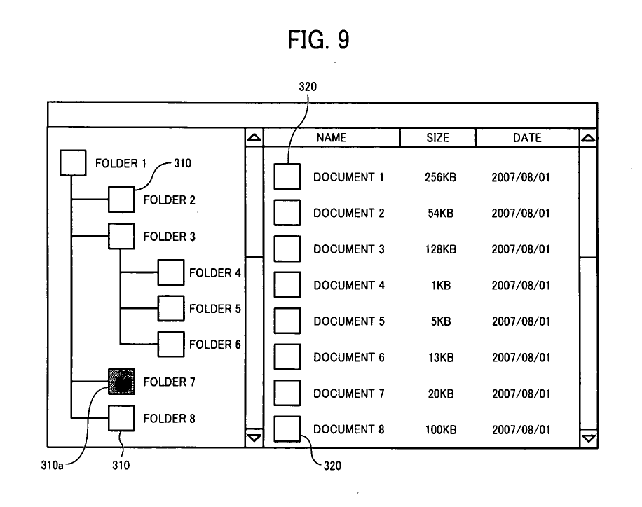

The folder 310 selected through the operation screen 600 is referred to as the classification folder 310a, which may be displayed differently from the other folders that are not selected to be the classification folders, or selected to be the normal folders. When the data file subjected to the extraction of classification information is registered in the folder 310 that is set as the classification folder, the data management module 208 applies operation of managing with respect to the registered data file. FIG. 9 illustrates a screen, which is displayed after the folder 310 is selected to be the classification folder 310a through the screen 300. Referring to FIG. 9, the folder 7 of the folders 310 is selected to be the classification folder 310a according to the user instruction through the instruction screen 600. The classification folder 310a is displayed differently from the other folders.

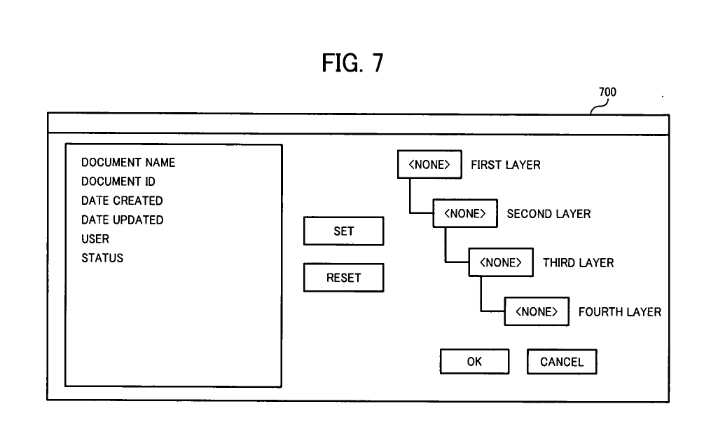

FIG. 7 illustrates an operation screen 700, which is used to set each layer of the tree structure of the classification folder 310a. For example, when the user selects the “Set Classification” button of the screen of FIG. 6, the operation screen 700 may be displayed. The operation screen 700 includes a display list for displaying the bibliographic items 510 stored in the table 500, a “Set” button for setting the bibliographic items 510 displayed in the display list as the names of the respective layers, and a “Reset” button for canceling the setting made through the “Set” button, and a plurality of display boxes each displaying the name of the corresponding one of the first layer to fourth layers. In this example, the operation screen 700 displays four layers including the first, second, third, and fourth layers. Alternatively, any desired number of layers may be displayed such that the fifth layer may be additionally displayed. The operation screen 700 further includes an “OK” button for confirming the name set for each of the layers, and a “Cancel” button for canceling the setting of the name.

Referring to FIG. 7, it is assumed that the user refers to the display list to select one of the bibliographic items 510 displayed on the display list. When the display box of one layer indicating the name is selected and the “Set” button is pressed, the bibliographic item 510 selected by the user is set as the name of the selected layer.

When the display box, which has been set with the name as described above, is selected by the user, and the “Reset” button is selected, the name that has been set for the selected layer is reset to display the message “None” on the display box.

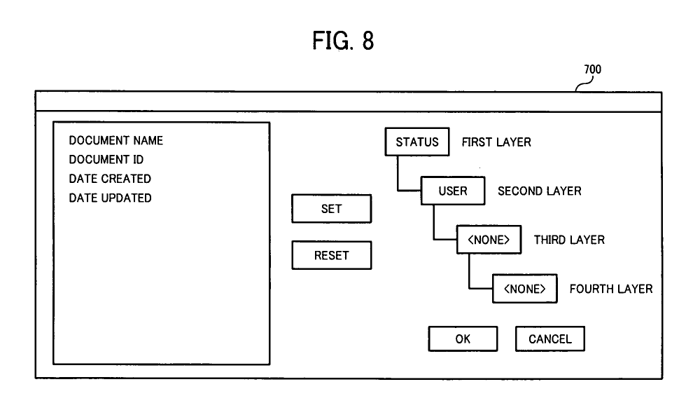

FIG. 8 illustrates an operation screen 700 when each layer of a plurality of layers having the tree structure is set for the classification folder 310a. Through the operation screen 700, the user sets the first layer with the name “Status” that corresponds to the bibliographic item 510 “Status”, and the second layer with the name “User” that corresponds to the bibliographic item 510 “User”. As illustrated in FIG. 8, the selected bibliographic items 510 are deleted from the display list of the operation screen 700.

When the upper layer, which is located above the current layer that has been set with the name, has not been set with any name such that the message “None” is displayed, the upper layer is displayed with the name that has been set to the current layer. For example, referring to FIG. 8, when the user does not set any name for the second layer such that the message “None” is displayed, and the third layer with the name “User”, the second layer is set with the name “User” such that the display box of the second layer displays the message “User”.

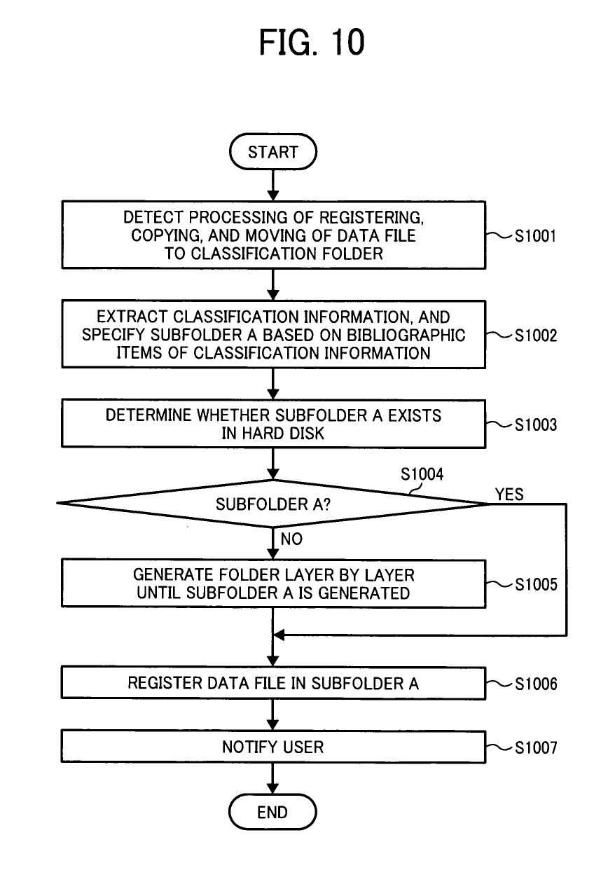

Referring to FIG. 10, operation of managing the data file using the layered folders after generating the layered folders, performed by the file management apparatus 100 of FIG. 1, is explained according to an example embodiment of the present invention.

As illustrated in FIG. 9, the display area controller 206 controls the functional modules to cause the display 114 to display thereon the display screen 300. When the user performs processing to the classification folder 310a, such as registration, copying, or moving of the data file such as the document data file or the image data file, at S1001, the data management module 208 detects the processing performed by the user with respect to the classification folder 310a.

At S1002, the data management module 208 analyzes the detected data file, extracts the classification information from the data file, and refers to the bibliographic items included in the extracted classification information. The data management module 208 specifies a folder that has been set with the name corresponding to the referred bibliographic item as a folder (“the registration folder”) to which the detected data file is registered. The data management module 208 selects the registration folder from the folders of the first layer of the classification folder 310a based on the name of the folder that is set with respect to the name of the first layer. The data management module 208 selects the registration folder from the folders of the second layer located below the selected registration folder of the first layer of the classification folder 310a, based on the name of the folder that is set with respect to the name of the second layer. The data management module 208 selects the registration folder from the folders of the third layer located below the selected registration folder of the second layer based on the name of the folder that is set with respect to the name of the third layer. In this manner, the data management module 208 selects and specifies the registration folder for all layers from the upper most layer to the lower most layer (or the subfolder path A).

At S1003 and S1004, the data management module 208 determines whether the registration folder, which has been specified for each layer at S1002, has been generated in the classification folder 310a. The data management module 208 reads the classification folder 310a from the hard disk device 120, and refers to the name and the folder each assigned to each layer of the classification folder 310a. The data management module 208 compares the layer and the folder that has been set with respect to the name of the bibliographic item at S1002, with the name and the folder with respect to each layer within the classification folder 310a. Based on the comparison, the data management module 208 determines whether each layer and each folder specified at S1002 is present in the classification folder 310a.

When it is determined that there is a layer or a folder, which does not exist in the classification folder 310a (“NO” at S1004), the operation proceeds to S1005. At S1005, the data management module 208 generates one or more folders for one or more layers, which have been specified at S1002, layer by layer, until it reaches the lower most layer or the subfolder path A.

When it is determined that all layers and folders are present in the classification folder 310a (“YES” at S1004), or when the folders are generated for all layers including the lower most layer at S1005, the operation proceeds to S1006. At S1006, the data management module 208 registers the data file into the folder of the lowest most layer, which is specified and generated, and stores the data file in the hard disk device 120.

At S1007, the data management module 208 causes the display 114 to display a message to notify the user that the data file has been registered according to the user instruction, and the operation ends. In this example, the message indicates that the data file has been registered to the subfolder A.

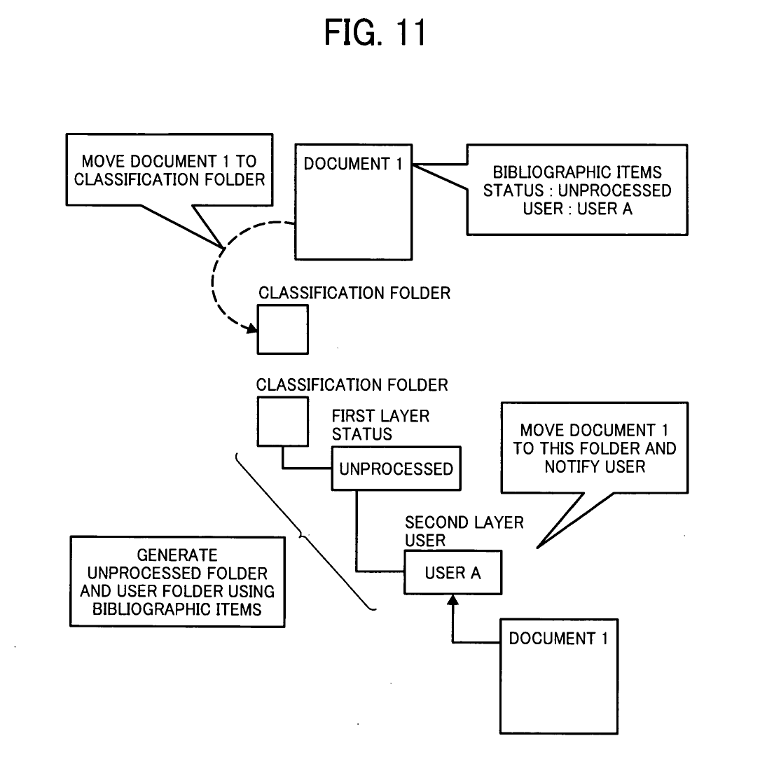

FIG. 11 illustrates an example case in which the data file, such as the document data file, is registered in the classification folder 310a having no layered folders that has been generated. For the descriptive purpose, it is assumed that the user has set the first layer with the name “Status”, and the second layer with the name “User” as described above referring to FIG. 8. Referring to FIG. 11, when the user performs operation indicating that the data file “Documents 1” is to be registered with respect to the classification folder 310a, the data management module 208 detects the user instruction for registering the data file “Document 1” into the classification folder 310a. For example, the user may drag and drop the data file “Document 1” to the classification folder 310a using the input device 122. The data management module 208 extracts the classification information from the data file “Document 1”, and refers to the bibliographic items of the classification information. In this example, the bibliographic items of the classification information extracted from the data file “Document 1” has the “Unprocessed” for the “Status” bibliographic item, and the “User A” for the “User” bibliographic item. Since the first layer has been set with the name “Status”, the data management module 208 specifies the folder of the first layer of the classification folder 310a according to the “Unprocessed” for the “Status” bibliographic item extracted from the data file. Since the second layer has been set with the name “User”, the data management module 208 specifies the folder of the second layer located below the first layer of the classification folder 310 according to the “User A” for the “User” bibliographic item extracted from the data file.

The data management module 208 generates the specified folders, layer by layer, from the upper most layer to the lower most layer. In this example, the “Unprocessed” folder is generated at the first layer, and the “User A” folder is generated at the second layer below the “Unprocessed” folder. The data management module 208 registers the data file “Document 1” to the folder “User A” of the lowest layer, and stores the data file “Document 1” in the hard disk device 120. More specifically, the data file “Document 1” is moved to the “User A” folder having the subfolder path “Unprocessed/UserA”, which is generated in the hard disk device 120. The data management module 208 notifies the user that registration of the data file “Document 1” has been completed. In this example, the data management module 208 may notify the user that the data file “Document 1” has been moved to the “User A” folder.

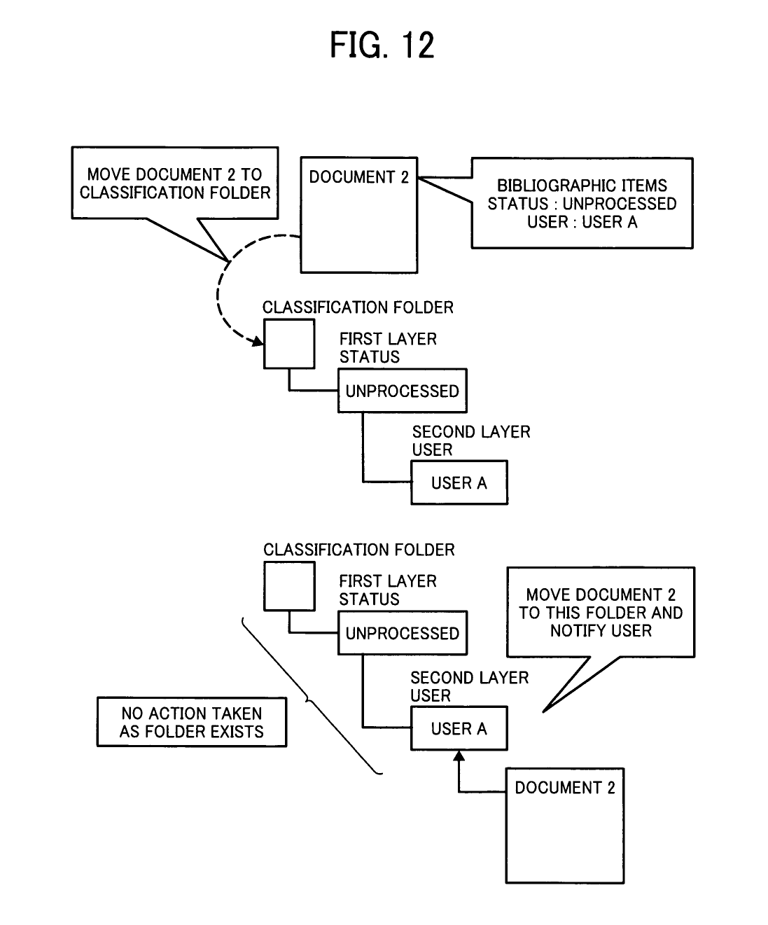

FIG. 12 illustrates an example case in which the data file, such as the document data file, is registered in the classification folder 310a having the layered folders that have been generated. For the descriptive purpose, it is assumed that the user has set the first layer with the name “Status”, and the second layer with the name “User” as described above referring to FIG. 8. Referring to FIG. 12, when the user performs operation indicating that the data file “Documents 2” is to be registered with respect to the classification folder 310a, the data management module 208 detects the user instruction for registering the data file “Document 2” into the classification folder 310a. For example, the user may drag and drop the data file “Document 2” to the classification folder 310a using the input device 122. The data management module 208 extracts the classification information from the data file “Document 2”, and refers to the bibliographic items of the classification information. In this example, the bibliographic items of the classification information extracted from the data file “Document 2” has the “Unprocessed” for the “Status” bibliographic item, and the “User A” for the “User” bibliographic item. Since the first layer has been set with the name “Status”, the data management module 208 specifies the folder of the first layer of the classification folder 310a according to the “Unprocessed” for the “Status” bibliographic item extracted from the data file. Since the second layer has been set with the name “User”, the data management module 208 specifies the folder of the second layer located below the first layer of the classification folder 310 according to the “User A” for the “User” bibliographic item extracted from the data file.

Since the specified folders are present in the classification folder 310a, the data management module 208 registers the data file “Document 2” into the folder “User A” of the lowest layer, and stores the data file “Document 2” in the hard disk device 120. More specifically, the data file “Document 2” is moved to the “User A” folder having the subfolder path “Unprocessed/User A”, which is generated in the hard disk device 120. The data management module 208 notifies the user that registration of the data file “Document 2” has been completed. In this example, the data management module 208 may notify the user that the data file “Document 2” has been moved to the “User A” folder.

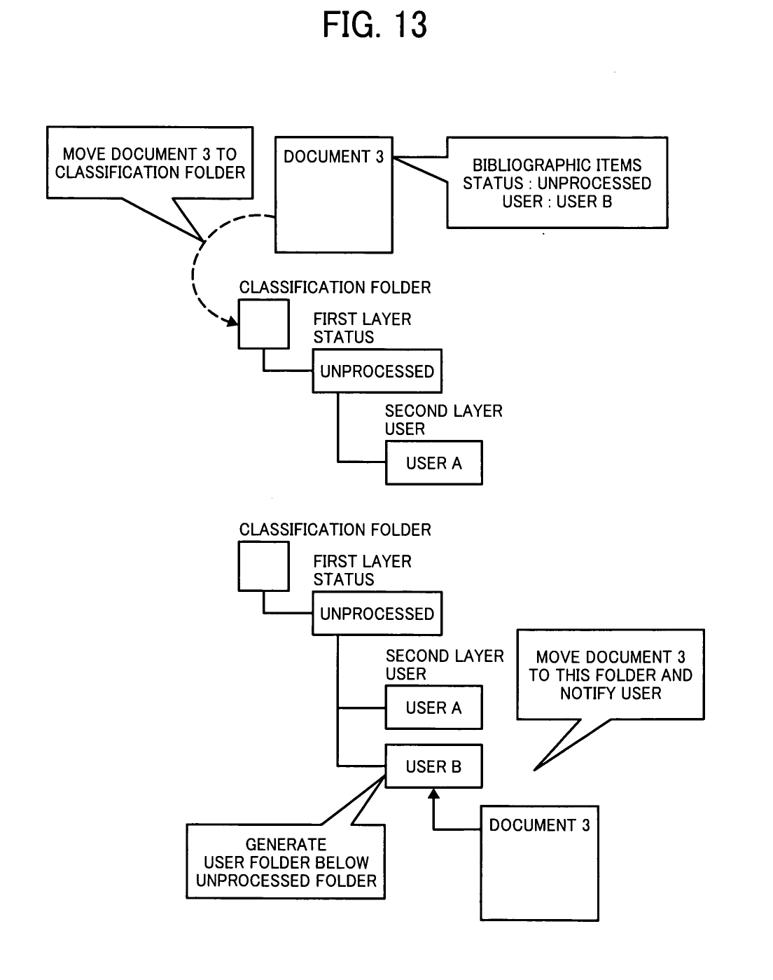

FIG. 13 illustrates an example case in which the data file, such as the document data file, is registered in the classification folder 310a having the layered folders that have been partly generated. For the descriptive purpose, it is assumed that the user has set the first layer with the name “Status”, and the second layer with the name “User” as described above referring to FIG. 8. Referring to FIG. 13, when the user performs operation indicating that the data file “Documents 3” is to be registered with respect to the classification folder 310a, the data management module 208 detects the user instruction for registering the data file “Document 3” into the classification folder 310a. For example, the user may drag and drop the data file “Document 3” to the classification folder 310a using the input device 122. The data management module 208 extracts the classification information from the data file “Document 3”, and refers to the bibliographic items of the classification information. In this example, the bibliographic items of the classification information extracted from the data file “Document 3” has the “Unprocessed” for the “Status” bibliographic item, and the “User B” for the “User” bibliographic item. Since the first layer has been set with the name “Status”, the data management module 208 specifies the folder of the first layer of the classification folder 310a according to the “Unprocessed” for the “Status” bibliographic item extracted from the data file. Since the second layer has been set with the name “User”, the data management module 208 specifies the folder of the second layer located below the first layer of the classification folder 310 according to the “User B” for the “User” bibliographic item extracted from the data file.

Since the folder “User B” of the second layer, which is the lower most layer, is not present, the data management module 208 generates the folder “User B” of the second layer. The data management module 208 registers the data file “Document 3” into the folder “User B” of the lower most layer, and stores the data file “Document 3” in the hard disk device 120. More specifically, the data file “Document 3” is moved to the “User B” folder having the subfolder path “Unprocessed/User B”, which is generated in the hard disk device 120. The data management module 208 notifies the user that registration of the data file “Document 3” has been completed. In this example, the data management module 208 may notify the user that the data file “Document 3” has been moved to the “User B” folder.

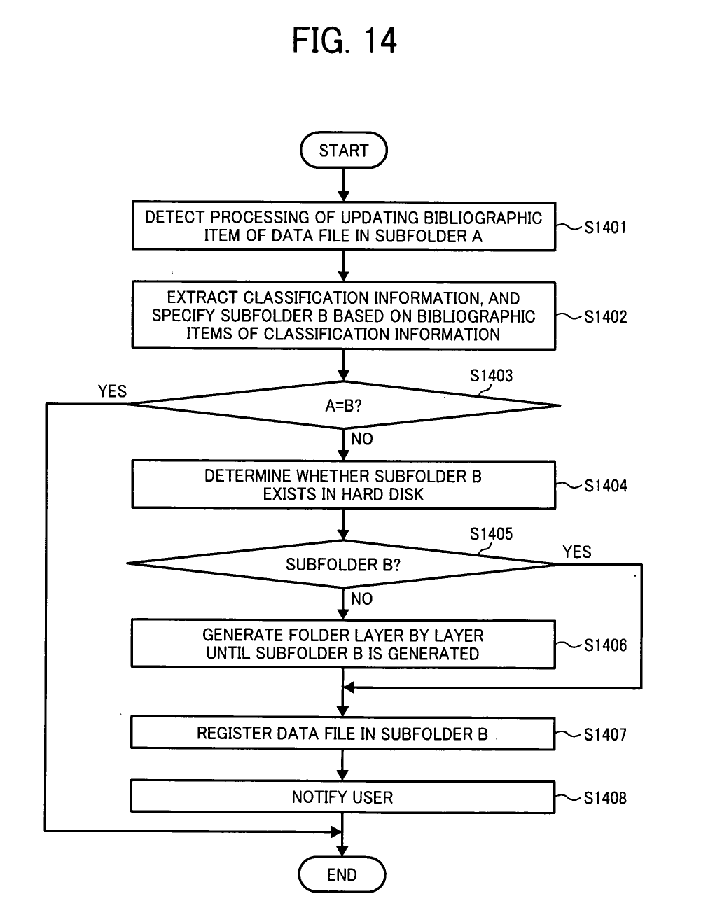

Referring to FIG. 14, operation of managing the data file using the layered folders when the classification information of the data file registered into the layered folder of the classification folder is updated, performed by the file management system 100, is explained according to an example embodiment of the present invention.

Assuming that the data file has been registered into the layered folder of the classification folder 310a, when the user performs processing to one of the registered data file, such as changing, adding, or updating the classification information or the bibliographic item of the data file, at S1401, the data management module 208 detects the processing performed by the user with respect to the registered data file.

At S1402, the data management module 208 analyzes the detected data file, extracts the updated classification information from the data file, and refers to the bibliographic items included in the updated classification information. The data management module 208 specifies a folder that has been set with the name corresponding to the referred bibliographic item as a folder (“the registration folder”) to which the detected data file is registered. The data management module 208 selects the registration folder from the folders of the first layer of the classification folder 310a based on the name of the folder that is set with respect to the name of the first layer. The data management module 208 selects the registration folder from the folders of the second layer located below the selected registration folder of the first layer, based on the name of the folder that is set with respect to the name of the second layer. The data management module 208 selects the registration folder from the folders of the third layer located below the selected registration folder of the second layer based on the name of the folder that is set with respect to the name of the third layer. In this manner, the data management module 208 selects and specifies the registration folder for all layers from the upper most layer to the lower most layer (or the subfolder path B).

At S1403, the data management module 208 determines whether the folder of the lower most layer specified at S1402 is the same as the registration folder of the classification folder 310 to which the data file has been registered. More specifically, the data management module 208 determines whether the subfolder path B is the same as the subfolder path A of FIG. 10. When it is determined that the folder of the lower most layer specified at S1402 is the same as the registration folder of the classification folder 310 (“YES” at S1403), the operation ends.

When it is determined that the folder of the lower most layer specified at S1402 is not the same as the registration folder of the classification folder 310 (“NO” at S1403), the operation proceeds to S1404. At S1404 and S1405, the data management module 208 determines whether the specified folder of each layer has been generated in the classification folder 310a. The data management module 208 reads the classification folder 310a from the hard disk device 120, and refers to the name and the folder each assigned to each layer of the classification folder 310a. The data management module 208 compares the layer and the folder that has been set with respect to the name of the bibliographic item at S1402, with the name and the folder with respect to each layer within the classification folder 310a. Based on the comparison, the data management module 208 determines whether each layer and each folder specified at S1402 is present in the classification folder 310a.

When it is determined that there is a layer or a folder, which does not exist in the classification folder 310a (“NO” at S1405), the operation proceeds to S1406. At S1406, the data management module 208 generates one or more folders for one or more layers, which have been specified at S1402, layer by layer, until it reaches the lower most layer or the subfolder path B.

When it is determined that all layers and folders are present in the classification folder 310a (“YES” at S1405), or when the folders are generated for all layers including the lower most layer at S1406, the operation proceeds to S1407. At S1407, the data management module 208 moves the data file into the folder of the lowest most layer, which is specified and generated, and stores the data file in the hard disk device 120.

At S1408, the data management module 208 causes the display 114 to display a message to notify the user that the data file has been registered according to the user instruction, and the operation ends. In this example, the message indicates that the data file has been registered to the subfolder B.

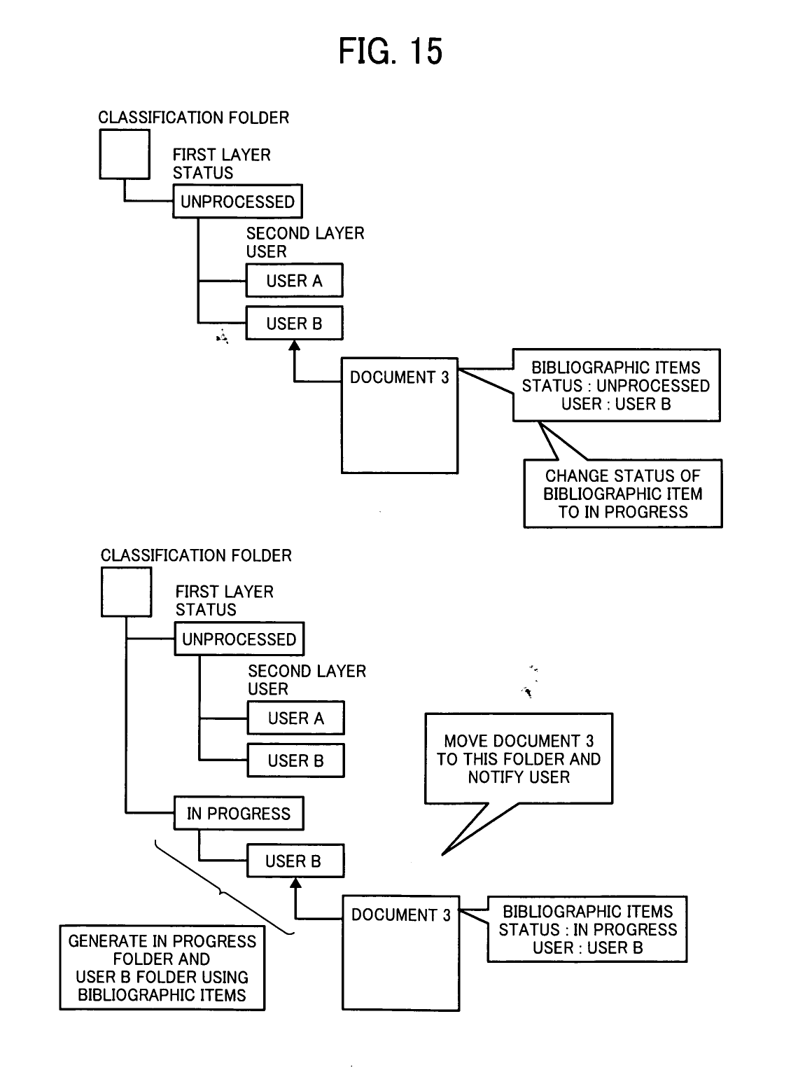

FIG. 15 illustrates an example case in which the classification information of the data file such as the document data file is updated, after the data file has been registered into the layered folder of the classification folder. Referring to FIG. 15, it is assumed that the data file “Document 3” has been registered with respect to the folder of the classification folder 310. When the classification information or the bibliographic item of the data file “Documents 3” has been changed, added, or updated according to the user instruction, the data management module 208 detects the user instruction for updating the classification information or the bibliographic item of the data file “Document 3”. The data management module 208 extracts the updated classification information from the data file “Document 3”, and refers to the bibliographic items of the updated classification information. In this example, the “Unprocessed” is changed to the “In Progress” for the Status bibliographic item. Based on the name “In Progress” of the folder that corresponds to the name “Status” assigned for the first layer, the data management module 208 specifies the folder of the first layer of the classification folder 310a. Based on the name “User B” of the folder that corresponds to the name “User” of the second layer, the data management module 208 specifies the folder of the second layer located below the first layer.

When the data management module 208 determines that the folder of the lower most layer is not the same as the registration folder to which the data file “Document 3” is registered, and when the folder of the first layer having the name “In Progress” and the folder of the second layer having the name “User B” do not exist, the data management module 208 generates a folder of the first layer with the name “In Progress” and a folder of the second layer with the name “User B”. The data management module 208 moves the data file “Document 3” to the folder having the name “User B” of the lower most layer, and stores the data file “Document 3” in the hard disk device 120. The data management module 208 notifies the user that registration of the data file “Document 3” has been completed. In this example, the data management module 208 may notify the user that the data file “Document 3” has been moved to the “User B” folder located under the “In Progress” folder.

As described above, in the file management system 100, when the user instruction is received, which indicates that the data file is to be registered into the classification folder 310a, the data management module 208 extracts the classification information from the data file, and refers to the bibliographic items of the extracted classification information. The data management module 208 specifies a registration folder, which has been set with the name corresponding to the bibliographic item, for each layer of the classification folder 310a. When the folder of any one of the layers is not present in the classification folder 310a, the data management module 208 generates the folder, layer by layer, until it reaches the folder of the lower most layer.

The data management module 208 registers the data file into the folder of the lower most layer, which has been specified and generated, and stores the data file in the hard disk device 120. More specifically, the data file is moved to the folder of the lower most layer.

Since the name to be assigned to each layer or each folder, which is used to specify the registration folder, is previously set and stored as the classification information or the bibliographic item under management by the user, and the file management system 100 specifies the registration folder to which the data file is to be registered according to the name extracted from the data file, the data file is automatically classified according to the user preference.

When the data file is registered into the classification folder 310a through the screen displayed by the display 114, the file management system 100 automatically specifies or generates a plurality of folders in layers within the classification folder 310a. Further, when the subfolder path is specified for the specific data file, the data file is automatically moved to the folder having the specified subfolder path. The user does not have to previously generate the plurality of folders in layers or manually register the data file to the folder. This frees the user from such cumbersome operation such that management of the data file can be performed more efficiently.

Processing of the display area controller 206 or the data management module 208 may be performed according to a computer program stored in the hard disk device 120.

In the above-described examples, the data management module 208 refers to all of the bibliographic items of the classification information to specify or generate the registration folder. Alternatively, the data management module 208 may refer to a selected or a restricted number of the bibliographic items of the classification information to specify or generate the registration folder.

Alternatively, the data management module 208 may set a number of layers of folders each having the name corresponding to the bibliographic item.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

In another example, the file management system 100 of FIG. 1 or 2 may be implemented in various other ways. For example, any one of the above-described operations of analyzing the data file to extract the classification information from the data file, generating the folders in layers based on the extracted classification information, and registering the data file to the folder specified based on the extracted classification information may be performed by more than one computer connected through the network.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc. Further, such computer program may be distributed over the network, for example, from a storage device onto any desired apparatus to cause the desired apparatus to function as the file management system 100 of FIG. 1.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in a file management system for managing a data file using a plurality of folders, the system including: a table to store a plurality of items regarding a plurality of layers used for classifying the data file; operating means for allowing a user to set each one of the plurality of layers having a tree structure by referring to the plurality of items stored in the table; extracting means for extracting classification information from the data file, the classification information being used to specify a registration folder to which the data file is registered by specifying, layer by layer, the plurality of folders based on the plurality of layers used for classifying the data file; generating means for comparing the classification information extracted by the extracting means with each one of the plurality of layers having the tree structure that is set by the operating means to generate the plurality of folders in the plurality of layers; and registering means for registering the data file to the registration folder specified based on the classification information.

More specifically, the extracting means extracts classification information regarding the plurality of layers used for classifying the data file. The data file may be a document data file or an image data file to be managed using the plurality of layers. The generating means refers to the classification information extracted by the extracting means, compares the extracted classification information with the table registering therein the classification information, and generates the plurality of folders in layers based on the classification information. For example, the generating means generates a folder of an upper layer corresponding to the “Status” bibliographic item of the classification information, and a folder of a lower layer corresponding to the “User” bibliographic item of the classification information.

The registering means registers the data file to a folder corresponding to the classification information of the data file for management. Even when the plurality of folders is generated in layers such that it has a tree structure, the data file may be automatically classified. The management of a large number of data files having a complicated classification system may be performed more efficiently and more accurately.

With the above-described function, the user is made free from cumbersome operation of manually generating the plurality of folders in layers, or copying or moving the data file to one of the plurality of folders. Further, since the bibliographic items are used for classification, the data file is classified using the plurality of folders according to the bibliographic items. Thus, the user may easily recognize how the data files are classified.

In the above-described example, the generating means refers to the classification information included in the data file to determine whether the folder specified by a bibliographic item of the classification information exists. When the folder specified by the bibliographic item of the classification information does not exist, the generating means generates the plurality of folders in layers according to the bibliographic item of the classification information, and assigns the folder specified by the bibliographic item of the classification information with the name corresponding to the bibliographic item of the classification information.

In the above-described example, the file management system further includes classification setting means for setting a classification folder for registering the data file from which the classification information is extracted by the extracting means.

Since the user can set the classification folder according to the user preference, automatic management of the data file may be only performed on the classification folder, while allowing the user to manually manage the data file with respect to the normal folder other than the classification folder.

In the above-described example, the classification setting means generates the classification folder such that the classification folder is displayed differently from folders other than the classification folder.

For example, the classification folder may be displayed in the different color, the different icon, or the different character.

In the above-described example, the file management system further includes designating means for designating the bibliographic item to be referred by the generating means.

Since the bibliographic items that are selected by the user are used for classification, the data file is classified using the plurality of folders according to the user preference. Thus, the user may easily recognize how the data files are classified.

In the above-described example, the file management system further includes notifying means for notifying a user of the registration folder to which the data file is registered by the registering means.

In the above-described example, the file management system further includes: detecting means for detecting the change made to the classification information included in the data file; update generating means for referring to the classification information that is detected for the change by the detecting means to generate a plurality of folders in layers based on the classification information that is detected for the change; and update registering means for registering the data file to the folder specified by the classification information that is detected for the change by referring to the classification information that is detected for the change.

In the above-described example, the update generating means refers to the classification information that is detected for the change by the detecting means to determine whether the folder specified by a bibliographic item included in the classification information exists. When it is determined that the folder specified by a bibliographic item included in the classification information does not exist, the update generating means generates the plurality of folders in layers according to the bibliographic item, and sets the folder specified by the bibliographic item included in the classification information with the name corresponding to the bibliographic item.

In another example, the present invention may reside in a file management method performed by a file management system including: receiving a user operation for setting each one of a plurality of layers having a tree structure by referring to a plurality of items regarding a plurality of layers used for classifying a data file stored in a table; extracting classification information from the data file, the classification information being used to specify a registration folder to which the data file is registered by specifying, layer by layer, a plurality of folders based on the plurality of layers used for classifying the data file; comparing the classification information extracted by the extracting means with each one of the plurality of layers having the tree structure that is set through the user operation to generate the plurality of folders in the plurality of layers; and registering the data file to the registration folder specified based on the classification information.

In the above-described example, the generating step includes referring the classification information included in the data file to determine whether the folder specified by a bibliographic item of the classification information exists. When the folder specified by the bibliographic item of the classification information does not exist, the generating step includes generating the plurality of folders in layers according to the bibliographic item of the classification information, and assigning the folder specified by the bibliographic item of the classification information with the name corresponding to the bibliographic item of the classification information.

In the above-described example, the method further includes setting a classification folder for registering the data file from which the classification information is extracted.

In the above-described example, the classification folder is generated such that the classification folder is displayed differently from folders other than the classification folder.

In the above-described example, the method further includes designating the bibliographic item to be referred by the generating step.

In the above-described example, the method further includes notifying a user of the registration folder to which the data file is registered by the registering step.

In the above-described example, the method further includes: detecting the change made to the classification information included in the data file; referring to the classification information that is detected for the change by the detecting step to generate a plurality of folders in layers based on the classification information that is detected for the change; and registering the data file to the folder specified by the classification information that is detected for the change by referring to the classification information that is detected for the change.

In the above-described example, the generating step includes referring to the classification information that is detected for the change by the detecting step to determine whether the folder specified by a bibliographic item included in the classification information exists. When it is determined that the folder specified by a bibliographic item included in the classification information does not exist, the generating step includes generating the plurality of folders in layers according to the bibliographic item, and setting the folder specified by the bibliographic item included in the classification information with the name corresponding to the bibliographic item.

In another example, any one of the above-described methods may be performed by a computer according to a computer program stored in a recording medium which causes the computer to perform any one of the above-described methods.

In another example, the present invention may reside in a recording medium storing therein a program for managing a data file which causes an file management system to include: a table to store a plurality of items regarding a plurality of layers used for classifying the data file; operating means for allowing a user to set each one of the plurality of layers having a tree structure by referring to the plurality of items stored in the table; extracting means for extracting classification information from the data file, the classification information being used to specify a registration folder to which the data file is registered by specifying, layer by layer, the plurality of folders based on the plurality of layers used for classifying the data file; generating means for comparing the classification information extracted by the extracting means with each one of the plurality of layers having the tree structure that is set by the operating means to generate the plurality of folders in the plurality of layers; and registering means for registering the data file to the registration folder specified based on the classification information.

In another example, the present invention may reside in a method of managing a data file using a plurality of folders arranged in a plurality of layers having a tree structure, the method including: storing a table in a storage device, the table including a plurality of bibliographic items relating to the contents of the data file, the plurality of bibliographic items including a plurality of bibliographic items to be used for classifying the data file; receiving, through an operation device, a user instruction for setting the plurality of layers by assigning each one of the plurality of layers with each one of the plurality of bibliographic items to be used for classifying the data file; extracting, using a controller device, classification information from the data file, the classification information including a plurality of bibliographic items; specifying, using the controller device, a registration folder to which the data file is to be registered by specifying, layer by layer, the plurality of folders using the plurality of bibliographic items of the classification information corresponding to the plurality of bibliographic items to be used for classifying the data file each assigned with the plurality of layers to be used for classifying the data file according to the user instruction; and registering, using the controller device, the data file to the registration folder included in the plurality of folders arranged in the plurality of layers.

In the above described example, the method further includes: determining whether any one of the plurality of folders specified using the plurality of bibliographic items of the classification information is present in the storage device to generate a determination result, and when the determination result indicates that at least one folder of the plurality of folders is not present, the controller device performs the steps of generating the at least one folder according to corresponding one of the plurality of bibliographic items of the classification information, and assigning the at least one folder with a name determined by the corresponding one of the plurality of bibliographic item of the classification information.

In the above-described example, the method further includes: receiving a user instruction for setting a classification folder subjected for management, wherein when the operation device detects a user instruction for registering the data file to the classification folder, the controller device is caused to automatically manage the data file.

In the above-described example, the method further includes: displaying the classification folder together with another folder that is not set to be the classification folder, wherein the classification folder is generated so as to cause the classification folder to be displayed differently from the another folder.

In the above-described example, the method further includes: receiving a user instruction for designating at least one of the plurality of bibliographic items included in the table to be at least one of the plurality of bibliographic items to be used for classifying the data file.

In the above-described example, the method further includes: notifying a user of the registration folder to which the data file is registered.

In the above-described example, the method further includes: detecting whether the classification information of the data file has been changed to updated classification information after the data file is registered; referring to the updated classification information to specify an updated registration folder to which the data file having the updated classification information is to be registered; and registering the data file having the updated classification information to the updated registration folder when the updated registration folder is determined to be different from the registration folder.

In the above-described example, the method further includes: determining whether the updated registration folder has been generated as one of the plurality of folders arranged in the plurality of layers, and when the updated registration folder has not been generated, the updated registration folder is generated to be included in the plurality of folders arranged in the plurality of layers.

In another example, any one of the above-described methods may be performed by a computer program stored in a recording medium, which causes a computer to perform any one of the above-described methods.

What is claimed is:

1. A file management system of managing a data file using a plurality of folders arranged in a plurality of layers having a tree structure, the system comprising:
a storage device configured to store a table including a plurality of bibliographic items relating to the contents of the data file, the plurality of bibliographic items including a plurality of bibliographic items to be used for classifying the data file;
an operation device configured to receive a user instruction for setting the plurality of layers to be used for classifying the data file by assigning each one of the plurality of layers to be used for classifying the data file with each one of the plurality of bibliographic items to be used for classifying the data file; and
a controller device configured to automatically manage the data file using the plurality of folders arranged in the plurality of layers, wherein the controller device includes:
an extracting device configured to extract classification information from the data file, the classification information including a plurality of bibliographic items;
a folder generating device configured to specify a registration folder to which the data file is to be registered by specifying, layer by layer, the plurality of folders using the plurality of bibliographic items of the classification information corresponding to the plurality of bibliographic items to be used for classifying the data file each assigned with the plurality of layers to be used for classifying the data file according to the user instruction; and
a registering device configured to register the data file to the registration folder included in the plurality of folders arranged in the plurality of layers.

2. The system of claim 1, wherein
the folder generating device is configured to determine whether any one of the plurality of folders specified using the plurality of bibliographic items of the classification information is present in the storage device to generate a determination result, and
when the determination result indicates that at least one folder of the plurality of folders is not present, the folder generating device is configured to generate the at least one folder according to corresponding one of the plurality of bibliographic items of the classification information, and to assign the at least one folder with a name determined by the corresponding one of the plurality of bibliographic item of the classification information.

3. The system of claim 2, wherein the operation device includes:
a classification folder setting device configured to receive a user instruction for setting a classification folder subjected for management by the file management system,
wherein when the operation device detects a user instruction for registering the data file to the classification folder, the controller device is caused to automatically manage the data file.

4. The system of claim 3, further comprising:
a display device configured to display the classification folder together with another folder that is not set to be the classification folder,
wherein the classification folder setting device is configured to generate the classification folder so as to cause the classification folder to be displayed differently from the another folder.

5. The system of claim 2, wherein the operation device further includes:
a designating device configured to receive a user instruction for designating at least one of the plurality of bibliographic items included in the table to be at least one of the plurality of bibliographic items to be used for classifying the data file.

6. The system of claim 5, further comprising:
a notifying device configured to notify a user of the registration folder to which the data file is registered.

7. The system of claim 2, wherein the controller device further includes:
a detecting device configured to detect whether the classification information of the data file has been changed to updated classification information after the data file is registered;
an updated folder generating device configured to refer to the updated classification information to specify an updated registration folder to which the data file having the updated classification information is to be registered; and
an updated registering device configured to register the data file having the updated classification information to the updated registration folder when the updated registration folder is determined to be different from the registration folder.

8. The system of claim 7, wherein
the updated folder generating device is configured to determine whether the updated registration folder has been generated as one of the plurality of folders arranged in the plurality of layers, and
when the updated registration folder has not been generated, the updated folder generating device is configured to generate the updated registration folder to be included in the plurality of folders arranged in the plurality of layers.

9. A method of managing a data file using a plurality of folders arranged in a plurality of layers having a tree structure, the method comprising:
storing a table in a storage device, the table including a plurality of bibliographic items relating to the contents of the data file, the plurality of bibliographic items including a plurality of bibliographic items to be used for classifying the data file;
receiving, through an operation device, a user instruction for setting the plurality of layers to be used for classifying the data file by assigning each one of the plurality of layers to be used for classifying the data file with each one of the plurality of bibliographic items to be used for classifying the data file;
extracting, using a controller device, classification information from the data file, the classification information including a plurality of bibliographic items;
specifying, using the controller device, a registration folder to which the data file is to be registered by specifying, layer by layer, the plurality of folders using the plurality of bibliographic items of the classification information corresponding to the plurality of bibliographic items to be used for classifying the data file each assigned with the plurality of layers to be used for classifying the data file according to the user instruction; and
registering, using the controller device, the data file to the registration folder included in the plurality of folders arranged in the plurality of layers.

10. A recording medium storing a plurality of instructions which cause a computer to perform a method of managing a data file using a plurality of folders arranged in a plurality of layers having a tree structure, the method comprising:
storing a table including a plurality of bibliographic items relating to the contents of the data file, the plurality of bibliographic items including a plurality of bibliographic items to be used for classifying the data file;
receiving a user instruction for setting the plurality of layers to be used for classifying the data file by assigning each one of the plurality of layers to be used for classifying the data file with each one of the plurality of bibliographic items to be used for classifying the data file;
extracting classification information from the data file, the classification information including a plurality of bibliographic items;
specifying a registration folder to which the data file is to be registered by specifying, layer by layer, the plurality of folders using the plurality of bibliographic items of the classification information corresponding to the plurality of bibliographic items to be used for classifying the data file each assigned with the plurality of layers to be used for classifying the data file according to the user instruction; and
registering the data file to the registration folder included in the plurality of folders arranged in the plurality of layers.
